(19) United States
(12) Patent Application Publication
(10) Pub. No.: US 2024/0002972 A1
(43) Pub. Date: Jan. 4, 2024

(54) LEACHING OF PRECIOUS AND CHALCOPHILE METALS

(71) Applicant: MINING AND PROCESS SOLUTIONS PTY LTD, Caulfield North, Victoria (AU)

(72) Inventors: Elsayed Abdelrady Oraby ABDALLA, Beckenham, Western Australia (US); Jacobus Johannes EKSTEEN, Bull Creek, Western Australia (AU)

(21) Appl. No.: 18/253,589

(22) PCT Filed: Nov. 18, 2021
(86) PCT No.: PCT/AU2021/051377

§ 371 Date: May 18, 2023

(30) Foreign Application Priority Data
Nov. 18, 2020 (AU) 2020904261

(51) Int. Cl. C22B 3/16; C22B 7/00; C22B 3/00; C22B 15/00

(52) U.S. Cl. CPC C22B 3/165; C22B 7/007; C22B 7/008; C22B 23/0415; C22B 23/0446; C22B 15/0067; C22B 15/0078

(57) ABSTRACT

A process for recovery of one or more target metals, selected from precious metals and chalcophile metals as respectively herein defined, from materials containing precious and/or chalcophile metal/s, said process including: (i) leaching the metal containing material with an aqueous solution containing: a “metal liberator” comprising an amino acid; and a “metal retainer” comprising one or more of ammonia, ammonium salts, carboxylic acids, carboxylic acid salts, dicarboxylic acids, dicarboxylic acid salts, hydroxy-carboxylic acids, hydroxy-carboxylic acid salts, ethylene diamine tetra-acetic acid (EDTA) and EDTA salts, to produce a leachate containing the target metal/s; and (ii) extracting the metal from the leachate.

### TECHNICAL FIELD

A process is disclosed for the recovery of one or more target metals, selected from precious metals and chalcophile metals, from materials containing precious and/or chalcophile metal/s. The process may be used to recover metals from ores, ore concentrates or tailings, or from other metal containing materials including jewellery, electronic scrap and other scrap materials. The process may be particularly used in the context of leaching low grade ores, ore concentrates or tailings in in-situ, heap or tank leach approaches. It may also be used for leaching process intermediates and/or secondary or waste materials. Waste materials may include any solid material that is derived by human activity, fabrication or processing such as, but not limited to, municipal wastes, electronic and electrical scrap (“e-waste”), mineral tailings, flue dusts, leach residues, slags, electrowinning and electro-refining slimes and sludges, any other metal bearing slimes and sludges and dross. The metal bearing material may also include contaminated soils.

As used herein, the term “precious metal” means gold (Au), silver (Ag) and the platinum group metals: ruthenium (Ru), rhodium (Rh), palladium (Pd), osmium (Os), iridium (Jr), and platinum (Pt). However, of these precious metals, the process is particularly applicable to the recovery of one or more of gold, silver, palladium and platinum and discussion will therefore focus on these precious metals.

As used herein, the term “chalcophile metal” means copper (Cu), nickel (Ni), cobalt (Co), zinc (Zn), lead (Pb), cadmium (Cd), thallium (Tl), indium (In), mercury (Hg), gallium (Ga), tin (Sn) and bismuth (Bi). However, of these chalcophile metals, the process is particularly applicable to the recovery of Ni, Co, Zn and Cu, more particularly Ni, Co and Cu, and discussion will therefore focus on these chalcophile metals. The process is more selective for these metals over other metals such as iron, magnesium, manganese, silicon and aluminum. The process is even more particularly applicable to the recovery of nickel and cobalt, such as from nickel and cobalt ores, by increasing the leachability and the stability of these metals in the leach solutions.

As used herein, term “lixiviant” refers to a dissolving agent that ensures phase transfer (i.e. from a solid to a liquid solution state of matter) whereby the targeted metal forms a complex with the lixiviant and the metal will not be soluble in the liquid state if not in the presence of the lixiviant.

### BACKGROUND ART

The recovery of chalcophile and/or precious metals is routinely conducted by hydrometallurgical processes. Different types of reagents have been previously used to leach copper and/or precious metals, usually depending on the pH regime of the ore environment. Many of those reagents have disadvantageous properties, such as toxicity, expense, lack of selectivity and low extraction rates, as is discussed in detail below.

Some ores are associated with alkaline environments. Conventional alkaline environments may use cyanide as a possible lixiviant. However, cyanide is extremely toxic.

In contrast to the above mentioned alkaline-associated ores, many ores are associated with conditions that have acidic conditions in their direct environment or are preceded by acidic pre-oxidation processes. In these environments, acidic leach processes have been more commonly employed. However, these acidic processes may also have attendant problems. A number of lixiviants are used in acidic environments (such as thiocyanate in the presence of an oxidant, chlorine-chloride systems, hypochlorite, bromine-bromide systems, acid-thiourea). For example, acidic thiourea is one alternative leach system to alkaline cyanide for gold extraction from some gold deposits. However, the use of these lixiviants is problematic due at least to toxicity and expense.

The present inventors have previously proposed the use of amino acids as possible lixiviants for the leaching of target metals such as chalcophile metals and/or precious metals. Amino acids are an attractive alternative to other more conventional lixiviants as they are environmentally safe and relatively inexpensive. However, it has been found that the target metals can exhibit limited solubility when using amino acids by themselves. Moreover, these lixiviants may require the presence of other species in solution (such as catalysts) which may introduce contaminants in downstream processing. Further, the previous amino acid based leaching systems developed by the inventors are often effective under only limited physicochemical conditions, particularly a limited solution pH range.

It would be desirable to provide an amino acid based leaching process and leaching solution that improved the solubility of chalcophile metals and/or precious metals. It would also be desirable to provide an amino acid based leaching process and leaching solution that was effective under a wider range of process conditions. It would be further desirable to provide a leaching process and leaching solution that was effective under a wider range of solution pH conditions. It would be further desirable to provide a leaching process and leaching solution that limited the addition of new reagents and therefore simplified the chemistry of the system.

The above references to the background art do not constitute an admission that the art forms a part of the common general knowledge of a person of ordinary skill in the art. The above references are also not intended to limit the application of the apparatus and method as disclosed herein.

### SUMMARY OF THE DISCLOSURE

The present inventors have surprisingly discovered that use of a leaching solution containing one or more metal liberators comprising an amino acid (or derivatives thereof, such as salts), and one or more metal retainers synergistically enhances the rate and/or extent of dissolution of chalcophile and/or precious metals in solution over a wide pH range.

As used herein, the term “metal liberator” refers to a species that functions to liberate the target metal from the material being leached. The metal liberator in the present case is a lixiviant typically comprising an amino acid or its derivative that ensures phase transfer (i.e. from a solid to a liquid solution state of matter) whereby ions of the targeted metal form aqueous complexes with the lixiviant.

As used herein, the term “metal retainer” refers to an aqueous species that complexes with the liberated ions of the target metal/s and extends the solubility limit of the liberated ions.

It has been found that amino acid by itself is unable to retain significant concentrations of target metals in solution once they are liberated. This property is not necessarily an issue where the material being treated contains a low concentration of the target metal, for example where the grade of the ore is low. Precious metals such as gold typically are present in ores at low grades, such as in the parts per million (grams per tonne) range. In contrast, chalcophile metals such as nickel and cobalt typically have ore grades expressed as a percentage (or at least a fraction of 1%), which is a difference of 4 or 5 orders of magnitude. In the latter case, because so much more target metal is present, a “metal retainer” is required to hold the chalcophile metal in solution while the amino acid functions as the “metal liberator”. For example, glycine is generally unable to hold more that about 5 g/L copper and more than about 8 g/L nickel in solution. This can be problematical when treating materials having high levels of target metals—such as e-waste. For example, e-waste may have high levels of copper—which would translate to correspondingly high copper concentrations in solution, such as around 30 to 50 g/L.

The inventors have discovered that the inclusion of one or more metal retainers in the leaching solution can appreciably increase the amount of target metal retained in solution. However, the need for a metal retainer may not be as important when the target metal is a precious metal.

The inventors have also found that the inclusion of one or more metal retainers in the leaching solution can appreciably extend the physicochemical conditions, in particular the pH range, of solubility of the target metal in solution.

In a first aspect there is disclosed a process for recovery of one or more target metals, selected from precious metals and chalcophile metals as respectively herein defined, from materials containing precious and/or chalcophile metal/s, said process including:
(i) leaching the metal containing material with an aqueous solution containing:
a “metal liberator” comprising an amino acid; and
a “metal retainer” comprising one or more of ammonia, ammonium salts, carboxylic acids, carboxylic acid salts, dicarboxylic acids, dicarboxylic acid salts, hydroxy-carboxylic acids, hydroxy-carboxylic acid salts, ethylene diamine tetra-acetic acid (EDTA) and EDTA salts,
to produce a leachate containing the target metal/s; and
(ii) extracting the metal from the leachate.

In a second aspect there is disclosed a target metal recovered by the above process.

As used herein, the term “amino acid” means an organic compound containing both a carboxyl (—COOH) and an amino (—NH₂) functional group. For ease of discussion, the term “amino acid” herein is intended to include derivatives of amino acids. The derivatives may include amino acid salts, such as alkali metal salts, for example, a sodium or potassium glycinate, or alkaline earth salts, for example a calcium salt, or ammonium salts. The derivative may alternatively or in addition comprise a peptide.

In many cases, the amino acid contains a —CHR or CH₂ group. In most cases the amino (—NH₂) group and the carboxyl (—COOH) group connects to the same —CHR or —CH₂ connecting group and are referred to primary a-amino-acids. The “R” group in the —CHR connecting group can take on any organic structure, such as aliphatic hydrocarbon groups to complex organic structures including aromatic groups, heterocyclic groups, and poly-nuclear groups or various other organic groups. In its simplest form, the R-group is only hydrogen, in which case the molecule reverts to the simplest primary a-amino-acid, called glycine. The amino acid may comprise one or more of Glycine, Histidine, Valine, Alanine, Phenylalanine, Cysteine, Aspartic Acid, Glutamic Acid, Lysine, Methionine, Serine, Threonine, and Tyrosine.

In an embodiment, the amino acid may be glycine (Gly) (chemically defined by the formula NH₂CH₂CO₂H). Glycine is a simple amino acid that is easy and cheap to produce on an industrial scale with the highest probability of industrial use. The following discussion will largely focus on the use of glycine and its salts as the amino acid, however, it is to be understood that the invention extends to other amino acids, in particular glutamic acid. “Glycine” may refer to the amino acid commonly known by this name, or any of its salts (such as sodium or potassium glycinate). Other common names for glycine include aminoacetic acid or aminoethanoic acid. In an embodiment, the amino acid is provided in an aqueous solution of an alkali, or alkaline earth, metal hydroxide (such as sodium or potassium hydroxide or calcium hydroxide).

Glycine and/or its salts are the preferred amino acid because of their:
large scale production and bulk availability;
low cost of production;
ease of transport;
chemical and thermal stability;
high solubility in water;
low price; and
low molecular weight.

While other amino acids may be used instead of (or in addition to) glycine, they are typically more costly and any performance benefit often cannot be justified by the additional costs that are incurred. Glycine has a very high solubility in water, is thermally stable, and stable in the presence of mild oxidants such as dilute hydrogen peroxide, manganese dioxide and oxygen. It is non-toxic and an environmentally safe and stable reagent. It is also cheap and available in bulk. The ability to easily regenerate, recover and reuse glycine in acidic solutions are some of its most important attributes from an economic perspective.

In another embodiment the amino acid is glutamic acid. Glutamic acid, similarly to glycine, is also cheap and available in bulk. However, its significantly higher molecular weight than glycine (147.13 g/mole compared with 75.05 g/mole for glycine) means it can be more difficult to handle than glycine.

The amino acid concentration in solution may vary from 0.01 to 250 grams per litre. In some embodiments, the concentration may be as high as 50 g/L. The minimum concentration may be 0.01 g/L, although it is typically at least 0.1 g/L. In some embodiments, the concentration of amino acid is at least 0.3 g/L. The concentration of amino acid is preferably at least 1 g/L. In an embodiment, the concentration of amino acid is at least 5 g/L, and may be at least 7 g/L. In another embodiment, the concentration of amino acid is at least 10 g/L.

The solution should preferably be substantially free of intentional additions of one or more potentially detrimental species such as thiosulphate, thiocyanate, thiourea, chlorine, bromine, hydrofluoric acid containing species, transition metal salts and strong oxidants such as H₂O₂. In most cases, this will mean that the solution is substantially free of those detrimental species. However, there may be cases where those detrimental species arise in situ in solution due to unintended reactions in solution.

The metal retainer/s are preferably selected from the following group:
ammonia, ammonium salts, carboxylic acids, carboxylic acid salts, dicarboxylic acids, dicarboxylic acid salts, hydroxy-carboxylic acids, hydroxy-carboxylic acid salts, ethylene diamine tetra-acetic acid (EDTA) and EDTA salts.

Examples of carboxylic acid salts and dicarboxylic acid salts include salts of acetate, oxalate (e.g. ferric oxalate), malonic acid and formic acid.

Examples of hydroxy-carboxylic acids and their salts include the salts of gluconic, citric, fumaric, tartaric, succinic, lactic and malic acids.

In an embodiment, the metal retainer comprises ammonia or an ammonium salt. The ammonium salt may comprise ammonium sulfate. Alternatively, the ammonium salt may be an ammonium halide, such as ammonium chloride, ammonium bromide or ammonium iodide. In another embodiment, the ammonium salt may be an ammonium carbonate. In another embodiment, the ammonium salt may be an ammonium nitrate. In another embodiment, the ammonium salt may be an ammonium oxalate. In another embodiment, the ammonium salt may be an ammonium acetate.

In the present process, ammonia or ammonium ions function to form complexes with the target metals to enhance their solubility and are not simply added to adjust solution pH. Accordingly, the ammonia or ammonium ions must be present in solution in a sufficient concentration to perform a metal retainer function.

The concentration of metal retainer will be dependent on the type and amount of target metal in the material that it is desired to be leached. In one embodiment, the concentration of metal retainer is at least 0.001 M. In another embodiment, the concentration of metal retainer is at least 0.005 M. In another embodiment, the concentration of metal retainer is at least 0.01 M. In another embodiment, the concentration of metal retainer is at least 0.05 M. In another embodiment, the concentration of metal retainer is at least 0.1 M. In another embodiment, the concentration of metal retainer is at least 0.2 M. In another embodiment, the concentration of metal retainer is at least 0.5 M. In another embodiment, the concentration of metal retainer is at least 0.7 M. In another embodiment, the concentration of metal retainer is at least 0.75 M. In another embodiment, the concentration of metal retainer is at least 0.8 M. In another embodiment, the concentration of metal retainer is at least 0.9 M. In another embodiment, the concentration of metal retainer is at least 1.0 M. In another embodiment, the concentration of metal retainer is at least 1.2 M. In another embodiment, the concentration of metal retainer is at least 1.5 M. In another embodiment, the concentration of metal retainer is at least 1.7 M. In another embodiment, the concentration of metal retainer is at least 2 M.

The concentration of metal retainer may be a maximum of 2.5 M. In one embodiment, the concentration of metal retainer may be a maximum of 2 M. In another embodiment, the concentration of metal retainer is a maximum of 1.5 M. In another embodiment, the concentration of metal retainer is a maximum of 1.25 M. In another embodiment, the concentration of metal retainer is a maximum of 1.2 M. In another embodiment, the concentration of metal retainer is a maximum of 1 M. In another embodiment, the concentration of metal retainer is a maximum of 0.75 M.

Where the metal retainer comprises ammonia or ammonium ions, the equivalent ammonia concentration for leaching precious metals may be a minimum of 50 ppm (3 mmol/L). In an embodiment, the minimum ammonia concentration for leaching precious metals may be 100 ppm (6 mmol/L). Where the metal retainer comprises ammonia or ammonium ions, the equivalent ammonia concentration range for leaching chalcophile metals may be a minimum of 1,000 ppm (60 mmol/L). In both cases, the maximum ammonia concentration may be 85,000 ppm (5 mol/L).

The mass of metal retainer in solution may be at least half the mass of metal liberator in solution. The mass ratio of metal liberator: metal retainer may be 10:1 or lower, such as 7:1 or lower. In an embodiment, the mass ratio of metal liberator: metal retainer is 5:1 or lower, such as 3:1 or lower. In another embodiment, the mass ratio of metal liberator: metal retainer is 2:1 or lower, such as 2:1.5 or lower. In another embodiment, the mass ratio of metal liberator: metal retainer may be 2:1.7 or lower. In another embodiment, the mass ratio of metal liberator: metal retainer may be 2:1.8 or lower. In another embodiment, the mass ratio of metal liberator: metal retainer may be 1:1 or lower. In another embodiment, the mass ratio of metal liberator: metal retainer may be 1:1.5 or lower.

In the leachate, the molar ratio between the target metal ions in solution and the metal retainer may be at least 1:2. The molar ratio may be as high as 1:8. In one embodiment, the molar ratio may be at least 1:2.5. In another embodiment, the molar ratio may be at least 1:3. In another embodiment, the molar ratio may be at least 1:4. In yet another embodiment, the molar ratio may be at least 1:5.

The leaching process may be conducted in the presence of an oxidant. Preferably, the oxidant is not a strong oxidant such as H₂O₂. Examples of simple oxidants which may be used include air (gaseous and dissolved states) and oxygen (gaseous and dissolved states). Other oxidants may include halogens, ferric or cupric ions, ozone, nitrate, chlorite, hypochlorite, persulfate, and iodine can also be used.

The leaching process may be conducted wherein the leach solution additionally includes a small amount of a catalyst. The catalyst may be selected from iodine and/or iodide, bromine and/or bromide, thiourea, and cyanides, or mixtures thereof.

The leaching solution may be acidic, neutral or alkaline. In an embodiment, the solution pH is at least 3. In another embodiment, the solution pH is at least 3.5. In another embodiment, the solution pH is at least 4. In another embodiment, the solution pH is less than 13. In another embodiment, the solution pH is less than 12. In another embodiment, the solution pH is less than 11. In another embodiment, the solution pH is no higher than 10.5. In another embodiment, the solution pH is no higher than 10.

In one embodiment, the leaching step (i) is conducted under acidic conditions. The process may be conducted using a moderately acidic solution having a pH range of between 0 and 7. In another embodiment, the pH range is between 1 and 6. In another embodiment, the pH is between 3 and 6. In another embodiment, the pH is between 4 and 6.

In another embodiment, the leaching step (i) is conducted under alkaline conditions. The process may be conducted using a leachant having a solution pH that is less than 13. In another embodiment, the solution pH is less than 12. In another embodiment, the solution pH is less than 11. In another embodiment, the solution pH is no higher than 10.5. In another embodiment, the solution pH is no higher than 10.

If required, a pH modifier may be added to solution to adjust pH. In order to reduce pH, a pH modifier can be any acid (organic or inorganic), for example sulfuric acid. Acid formation can also result from the in situ oxidation of sulfide minerals in the presence of oxygen (or other oxidant) and water, or by waters that are naturally acidic, as well as waters derived from acid mine drainage or acid rock drainage. If it is instead desired to increase pH, an alkaline species, such as NaOH, may be added to solution.

The material containing the precious metal and/or chalcophile metal may comprise an ore or an ore concentrate (herein collectively referred to as “ore” for easy discussion). The material may alternatively comprise a waste material, including mining waste such as tailings, industrial waste such as fly ash, or electronic waste (“e-waste”), such as computers, keyboards, televisions, mobile phones, etc. The material may be electrical and municipal waste. The material may be dross, slags, flue dusts and mattes derived from pyrometallurgical processing operations. The material may instead be a mining or metallurgical process intermediate such as precipitates, residues, or metal-bearing sludges or slimes (e.g. derived from electrowinning and electro-refining). The material may be metal-contaminated soils. While the following discussion will focus on the use of the recovery process for treating ores, it is to be understood that it is not limited thereto and is applicable to all solid precious metal and/or chalcophile metal-containing materials.

The precious metal and/or chalcophile metal-containing materials most often occur as sulfide minerals in ores, although oxides, arsenides, sulfo-arsenides, native metals, tellurides, sulfates, carbonates, chlorides, silicates, hydroxylated-salts and hydroxide minerals may also occur commonly.

In an embodiment, the process recovers non-precious metals. The process is applicable to the recovery of nickel, cobalt or copper. It is more particularly applicable to the recovery of nickel and cobalt, such as from nickel and cobalt ores.

The process may be applicable to the recovery of metals, such as copper, from electronic waste (e-waste).

In an embodiment, the leaching may take place “in situ” or “in place” (i.e., in the underground rock mass through use of a well-field). In another embodiment, the leaching may comprise dump leaching, such as by leaching blasted but uncrushed particles typically smaller than 200 mm. In another embodiment, the leaching may comprise heap leaching, such as by leaching coarse crushed particles typically smaller than 25 mm. In another embodiment, the leaching may comprise vat leaching, such as by leaching fine crushed, particles typically smaller than 4 mm. In another embodiment, the leaching may comprise agitated tank leaching, such as by leaching milled material having particles typically smaller than about 0.1 mm/100 micrometre. In another embodiment, the leaching may take place in pressure leaching autoclaves and may comprise leaching particles that are typically smaller than 100 micrometre.

Where the metal retainer comprises ammonia or ammonium ions, the leaching process preferably does not comprise in situ, dump or heap leaching given that ammonia is evaporative and potentially toxic.

The recovery process may be conducted over a range of temperatures where water remains in the liquid state at a given system pressure. In an embodiment, the process is conducted at ambient or mildly elevated temperatures. The process may be conducted from −10° C. to 200° C., such as from 0° C. to 100° C. Where the temperature is elevated, the temperature may be a minimum of 30° C., such as at least 40° C. The maximum temperature may be the boiling point of the solution. In an embodiment the process may be conducted at a temperature up to 75° C. In one embodiment, the process is conducted at a temperature between 20° C. and 65° C.

The recovery process may conveniently be conducted at atmospheric pressure (from mean sea level to low atmospheric pressures at altitudes of around 6000 meters above mean sea level). However, in some embodiments, the process may be conducted at elevated pressure or at a pressure below atmospheric. The pressure may range from 0.01 bar to 1000 bar. However, it is typically between 0.5 and 1.5 bar.

The leaching step may occur in the presence of variable amounts of dissolved oxygen which may, for example, be provided via aeration or oxygenation. Dissolved oxygen (DO) concentrations may vary from 0.1-100 milligrams per litre in solution, such as from 2 to 30 mg/L, depending on the oxygen demand (OD) of the CPMs in solution and the pressure of the leaching process.

The process can be used with various water types, i.e. tap water, river water, sea water, as well as saline and hypersaline brines with significant dissolved salts containing sodium, magnesium, calcium, chloride, sulfate and carbonate ions in solutions.

The precious metal and/or chalcophile metal-containing materials and the leachant react to leach the target metal/s into the leachate. Without wishing to be limited by theory, it is believed that the metal liberator (typically an amino acid) solubilises the target metal from the material. The presence of the metal retainer further enhances the metal's liberation from the material and also forms complexes with the target metal/s to a greater extent than amino acids alone.

The ratio of solid precious metal and/or chalcophile metal-containing materials to the lixiviant can vary. For example, in the case of in-situ leaching, the solid to liquid ratio is likely to be high, such as up to 100:1. In agitated tank leaching the solid to liquid ratio is likely to be much lower, such as around 50:50, or 1:1, on a weight basis (i.e. 50 kg of solid to kg of aqueous solution). In the case of leaching mineral concentrates, the ratio may be even lower, such as around 10 kg of solids per 90 kg of aqueous solution (i.e., 1:9). Other than there being some metal/mineral-bearing solid present, there is no minimum amount of solid relative to the (lixiviant—bearing) liquid phase.

Accordingly, the leach system used in the disclosed process comprises as a minimum the following components:
A solid material containing the precious metals and/or chalcophile metals of interest.
An ionising solvent such as water.
Optionally, a pH modifier such as a strong inorganic acid (such as sulfuric acid) or a base (such as NaOH).
A metal liberator, typically comprising an amino acid.
A metal retainer comprising one or more of ammonia, ammonium salts, carboxylic acids, carboxylic acid salts, dicarboxylic acids, dicarboxylic acid salts, hydroxy-carboxylic acids, hydroxy-carboxylic acid salts, ethylene diamine tetra-acetic acid (EDTA) and EDTA salts. The metal retainer may be either pre-prepared prior to addition to the solution or is formed in-situ in solution.

Once leached, the metals may be recovered from aqueous solution using one of a range of extraction steps.

Possible recovery steps may comprise chemical recovery such as by recovering the metal in a solid state (such as electrowon metal, hydrogen precipitated metal powders, or as a metal sulfide precipitate). The precious metals may also be recovered by zinc cementation (e.g. such as the Merrill Crowe process used commonly in precious metals recovery from solution). An alternative recovery step may comprise use of ion-exchange (IX) resins, solvent extraction (SX) organic solvents, activated carbon, molecular recognition (MR) resins, or coated adsorbents (CA's), which may include polyethylene immine (PEI) coated diatomaceous earth, ferrofluids, and CPM-selective organic adsorbents grafted onto solid matrices. The metal is preferably not recovered by adding a carbonising agent (such as CO₂ or a carbonate salt) in order to precipitate the metal as a metal carbonate.

Where the target metal is a chalcophile metal, the recovery step may include solvent extraction (SX). The recovery step may further include an electrowinning step (EW). In an embodiment, the recovery step comprises solvent extraction and electrowinning (SX/EW). In SX/EW, the metal ions are selectively extracted from the aqueous leach solution into a solvent.

The metal ions are then stripped from the solvent and deposited onto electrodes using an electrolytic process.

Where the target metal is a precious metal, the recovery step may comprise using activated carbon to adsorb the precious metal thereon. The activated carbon and adsorbed precious metal is then separated and treated to recover the adsorbed metal.

### BRIEF DESCRIPTION OF THE DRAWINGS

Notwithstanding any other forms which may fall within the scope of the apparatus and method as set forth in the Summary, specific embodiments will now be described, by way of example only, with reference to the accompanying drawings in which:

FIG. 1 is a graph showing nickel recovery (%) versus time (hours) in solutions at pH 10, 40% solids at room temperature, containing as lixiviants:
GlyAmm: 46.3 g/L glycine, 63 g/L (0.5M ammonium sulfate) (diamonds);
Gly: 46.3 g/L glycine (triangles):
Amm: 63 g/L (0.5M ammonium sulfate) (squares).

FIG. 2 is a graph showing cobalt recovery (%) versus time (hours) in solutions at pH 10, 40% solids at room temperature, containing as lixiviants:
GlyAmm: 46.3 g/L glycine, 63 g/L (0.5M ammonium sulfate) (diamonds);
Gly: 46.3 g/L glycine (triangles):
Amm: 63 g/L (0.5M ammonium sulfate) (squares).

FIG. 3 is a graph showing copper extraction (%) from chalcopyrite versus time (hours) using amino acid solutions either in the absence of or in the presence of 0.3M of different additives. The amino acid solutions are glycine (crosses), glutamic acid (open circles), glycine and ammonia (closed circles), glutamic acid and ammonia (squares), glycine and acetate (diamonds) and glycine and citrate (triangles).

FIG. 4 is a graph showing copper extraction (%) versus time (hours) using glycine solutions either in the absence of (squares) or in the presence of (circles) ammonia.

### DETAILED DESCRIPTION OF SPECIFIC EMBODIMENTS

### Examples

Non-limiting Examples of a process for the recovery of one or more elements, selected from precious metals and chalcophile metals, are described below. The following abbreviations are used for lixiviants: “GlyAmm” is used for the system Glycine-Ammonium, “Gly” refers to Glycine, “Amm” refers to ammonium. The pressure and temperature of all Examples were 1 atmosphere and room temperature (20 deg C), respectively.

### Example 1

Cyclone overflow of a nickel ore containing 0.67% Ni was leached with a solution containing 46.3 g/L glycine and 63 g/L (0.5M ammonium sulfate) (GlyAmm) at pH 10 and 40% solids at room temperature. Nickel recovery versus time was compared with that using two other leachants comprising 46.3 g/L glycine (Gly) and 63 g/L (0.5M ammonium sulfate) (Amm), respectively, under the same conditions. The results are presented in FIG. 1. It can be seen that nickel recovery is significantly higher when leached with the GlyAmm solution (diamonds) than when leached with the Gly solution (triangles) or the Amm solution (squares). Moreover, the nickel recovery when leached with the GlyAmm solution is more than the sum of the recoveries using the Gly and the Amm solutions, indicating the synergistic effect of the GlyAmm solution.

### Example 2

Cyclone overflow of nickel-cobalt ore concentrate containing 0.15% Co was leached with a solution containing 46.3 g/L glycine and 63 g/L (0.5M ammonium sulfate) (GlyAmm) at pH 10 and 40% solids at room temperature. Cobalt recovery versus time was compared with that using two other leachants comprising 46.3 g/L glycine (Gly) and 63 g/L (0.5M ammonium sulfate) (Amm), respectively, under the same conditions. The results are presented in FIG. 2. Similarly, for nickel recovery in Example 1, it can be seen that cobalt recovery is also significantly higher when leached with the GlyAmm solution (diamonds) than when leached with the Gly solution (triangles) or the Amm solution (squares). Moreover, the cobalt recovery when leached with the GlyAmm solution is more than the sum of the recoveries using the Gly and the Amm solutions, indicating the synergistic effect of the GlyAmm solution.

### Example 3

Pulverised chalcopyrite concentrate was leached with two leaching solutions: a Gly solution containing 0.5 M glycine and a GlyAmm solution containing 0.5 M glycine and 1 M ammonia in a bottle roller. In both cases, leaching was conducted at room temperature, at pH of 10 and at a bottle roller speed of 100 rpm. The results are presented in Table 1. It can be seen that the recovery of the precious metals gold and silver was significantly higher (up to a factor of 5 for gold) in the GlyAmm system. Copper recovery was also much higher when leached with GlyAmm: 85% as compared with only 50% when leached with glycine alone.

TABLE 1

| | Au | Ag | As | Cu | Ni | Zn | Al | Ca |
|---|---|---|---|---|---|---|---|---|
| | ug/L | mg/L | mg/L | mg/L | mg/L | mg/L | mg/L | mg/L |
| Gly (0.5M | 5 | 0.017 | 0.5 | 460 | BDL | 15.5 | 2 | 6 |
| glycine) | | | | | | | | |
| GlyAmm | 27 | 0.041 | 0.9 | 803 | BDL | 21.5 | 1.5 | 22 |
| (0.5 glycine + | | | | | | | | |
| 1M ammonia) | | | | | | | | |
| | | Rec % | Gly | 50.0 | | | | |
| | | | GlyAmm | 85.5 | | | | |

BDL = below the detection limit

### Example 4

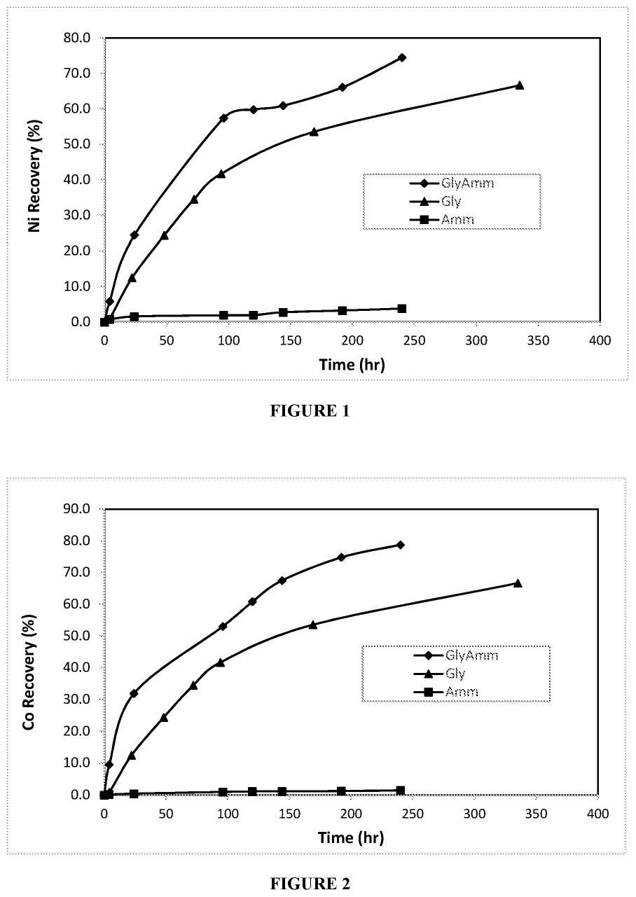

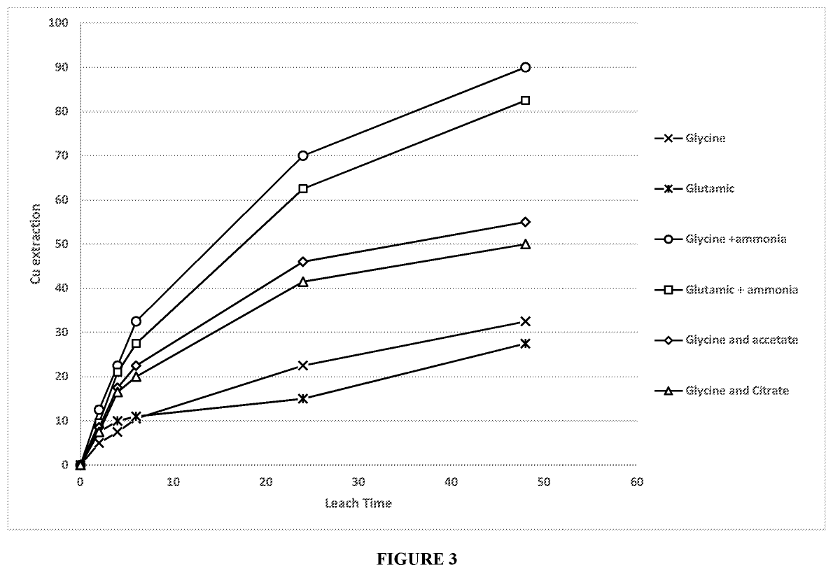

Chalcopyrite ore containing 22.1% Cu was leached with various amino acid-based solutions under the following conditions: 10 g/L amino acids, 1% solid content, particle size: 100%-45 μm, pH 10.5, and at room temperature. The results are shown in FIG. 3, where copper extraction (%) is plotted against leach time (hours). The amino acid solutions comprise glycine or glutamic acid either alone or in the presence of 0.3 M different respective additives. The amino acid solutions are glycine (crosses), glutamic acid (open circles), glycine and ammonia (closed circles), glutamic acid and ammonia (squares), glycine and acetate (diamonds) and glycine and citrate (triangles).

The results show that leaching with either glycine or glutamic acid is enhanced in the presence of metal retainers such as ammonia, acetate ions or citrate ions. Generally, glycine-based solutions provide greater recoveries than glutamic acid-based solutions for any given leach time. Of the three metal retainers illustrated in FIG. 3, ammonia offers the greatest improvement in copper solubility, with the combination of glycine and ammonia providing the highest recovery of copper (90% recovery after a 48 hour leach).

### Example 5

A mixed hydroxide precipitate (MHP—an intermediate product produced during hydrometallurgical processing of nickel laterite ore), containing 30% Ni and 2.5% Co, was leached using respective glycine solutions with and without ammonia. In each case, the solution conditions were: 40 g/L glycine, 1% solid content, pH 10, and at room temperature and a leach time of 4 hours. The GlyAmm solution additionally contained 0.3M ammonia.

The results are set out in Table 2 below:

TABLE 2

| | Glycine | Glycine-ammonia |
|---|---|---|
| Ni % | 98.8 | 100 |
| Co % | 75.3 | 98.6 |

While a slightly higher recovery of nickel was achieved when ammonia is present in the leaching solution, there was a significantly higher (>20%) recovery of cobalt using the GlyAmm solution.

### Example 6

A mixture of copper and nickel (sulfate) salts was dissolved at room temperature in alkaline solutions (pH 10.5) containing amino acids with and without additional metal retainers. Each solution contained 1M amino acid and, where appropriate, 1M metal retainer. The results are set out below in Table 3.

TABLE 3

| | Gly- | Glu- | Glycine − | Glycine + | Glycine + | Glycine + |
|---|---|---|---|---|---|---|
| | cine | tamic | ammonia | Gluconic | citrate | EDTA |
| Cu g/L | 4.5 | 5.6 | 25.2 | 26.2 | 25.3 | 29.5 |
| Ni g/L | 8.5 | 7.5 | 27.1 | 28.0 | 27.3 | 28.5 |

The results indicate that, under the conditions of this particular sample, relatively low recoveries of copper and nickel were observed when the sample was treated with solutions containing glutamic acid or glycine per se. Recoveries were significantly improved when metal retainers were respectively added to the amino acid solutions. In most cases, the nickel concentration was higher than for copper in each solution. Similar recoveries were observed when ammonia or citrate ions were the metal retainers. Slightly higher recoveries were observed when gluconic acid was the metal retainer. The highest recovery was obtained using the combination of glycine and EDTA.

### Example 7

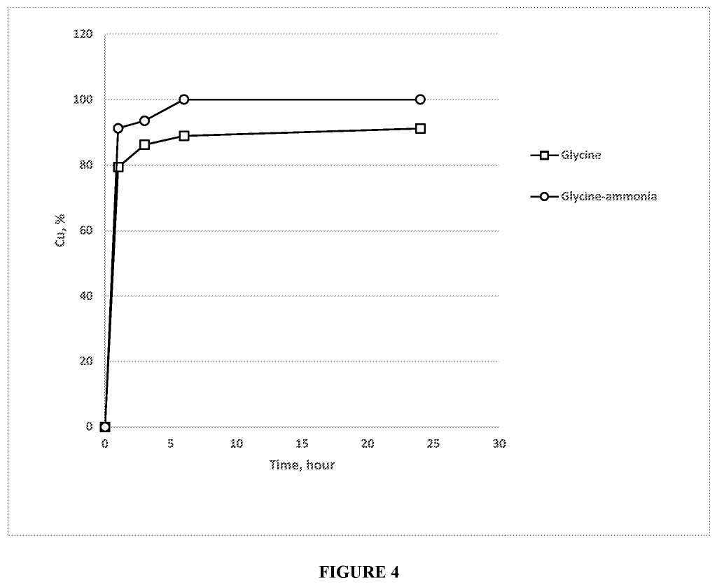

A copper oxide ore sample containing 66% malachite, 16.7% quartz and 3.35% hematite was leached in 20 g/L glycine in the absence and presence of 0.3M ammonia at pH and room temperature. The results are shown in FIG. 4, which is a plot of copper recovery (%) versus leach time (hours). Squares represent copper recovery in the absence of ammonia and circles represent copper recovery in the presence of ammonia. In the presence of ammonia, copper recovery reached 100% after 6 hours. However, in the absence of ammonia, the maximum recovery was only about 90%.

### Example 8

A sample comprising metal oxide alkaline battery waste containing 43% Zn, 51% Mn and 0.5% Cu was leached in a solution containing 20 g/L glycine in the absence and presence (respectively) of 0.4M ammonia at pH 10.5 and room temperature for 24 hours. The sample was also leached in a solution containing 20 g/L glutamic acid and 0.4M ammonia. The results are set out in Table 4.

TABLE 4

| | Glycine | Glycine-ammonia | Glutamic-ammonia |
|---|---|---|---|
| Zn % | 32 | 85.2 | 81.3 |
| Cu % | 70.2 | 85 | 80.7 |
| Mn % | 0.1 | 2.1 | 0.5 |

The results show very good selectivity for zinc and copper over manganese. Further, there is a significant improvement in recovery of each of zinc, copper when the waste material is leached with a combination of glycine and ammonia, as compared to leaching with glycine alone. Moreover, leaching with a combination of glycine and ammonia also enhances recovery of both metals as compared with leaching with glutamic acid and ammonia.

### Example 9

Material comprising nickel sulphide as pentlandite and containing 17% Ni, 0.45% Co, and 0.15% Zn was leached with glycine-based solutions having 20 g/L amino acids (glycine), pH 10, and at room temperature. In the first leaching solution, a glycine (20 g/L)-ammonia (10 g/L NH₃) mixture was used to leach the pentlandite. The pH was readjusted during the leaching to pH 10, if required, by further additions of ammonia. In the second leaching solution, glycine only solutions were used and sodium hydroxide (NaOH) was used to readjust pH, if required.

The results of leaching with the first and second solutions are presented in Tables 5 and 6, respectively.

TABLE 5

| | Ni | Co | Zn | S | Fe | Mg |
|---|---|---|---|---|---|---|
| Metals in (g) | 4.46 | 0.122 | 0.041 | 2.729 | 2.172 | 3.90 |
| Metals out | 0.746 | 0.04 | 0.009 | 1.0943 | 1.4823 | 3.24 |
| residue (g) | | | | | | |
| Metals out | 3.65 | 0.092 | 0.028 | 1.9520 | 0.457 | 0.27 |
| soluition (g) | | | | | | |
| Totla out (g) | 4.40 | 0.128 | 0.037 | 3.0463 | 1.9393 | 3.51 |
| Recovery, % | 81.9 | 75.5 | 69.1 | 71.53 | 21.0 | 6.86 |
| Recovery, % | 83.0 | 71.95 | 75.10 | 64.1 | 23.6 | 7.6 |
| solu/Res | | | | | | |

TABLE 6

| | Ni | Co | Zn | S | Fe | Mg |
|---|---|---|---|---|---|---|
| Metals in (g) | 4.458 | 0.122 | 0.041 | 2.729 | 2.172 | 3.902 |
| Metals out | 0.860 | 0.038 | 0.022 | 0.589 | 1.503 | 3.296 |
| residue (g) | | | | | | |
| Metals out | 3.007 | 0.070 | 0.011 | 1.877 | 0.230 | 0.079 |
| soluition (g) | | | | | | |
| Totla out (g) | 3.867 | 0.109 | 0.033 | 2.466 | 1.733 | 3.375 |
| Recovery, % | 67.4 | 57.8 | 27.1 | 68.8 | 10.6 | 2.0 |
| Recovery, % | 77.8 | 64.6 | 33.8 | 76.1 | 13.3 | 2.3 |
| solu/Res | | | | | | |

The results in Tables 5 and 6 demonstrate the significantly better recovery of nickel, cobalt and zinc using a leaching solution that contains ammonia in combination with glycine as compared with a leaching solution that simply contains NaOH for pH modification.

The same material was also leached with an acidic leaching solution that included glycine and citrate at a solution pH of 4. The solution contained 20 g/L glycine and 20 g/L citric acid. The results are set out below in Table 7.

TABLE 7

| | Ni | Co | Zn | S | Fe | Mg |
|---|---|---|---|---|---|---|
| Metals in (g) | 4.46 | 0.122 | 0.041 | 2.729 | 2.172 | 3.90 |
| Metals out | 0.879 | 0.04 | 0.008 | 1.0777 | 1.1507 | 2.41 |
| residue (g) | | | | | | |
| Metals out | 3.45 | 0.085 | 0.029 | 1.9820 | 0.857 | 0.47 |
| soluition (g) | | | | | | |
| Totla out (g) | 4.33 | 0.122 | 0.037 | 3.0597 | 2.0077 | 2.88 |
| Recovery, % | 77.4 | 69.9 | 71.6 | 72.63 | 39.4 | 12.05 |
| Recovery, % | 79.7 | 69.40 | 79.18 | 64.8 | 42.7 | 16.3 |
| solu/Res | | | | | | |

The results in Table 7 indicate that relatively high recoveries of Ni, Co and Zn can also be achieved at acidic pH by leaching with a glycine and citrate solution instead of a glycine and ammonia solution. Acidic leaching may be desirable for certain types of ore materials as well as e-waste. However, it is noted that there is a loss of selectivity of the target metals over other elements in the material, in particular Fe and Mg, under these acidic conditions. It may therefore be necessary to include a neutralisation step after the leaching step, and subsequently precipitate the other elements from solution.

### Example 10

The extraction of precious metals, including palladium and platinum, from a nickel concentrate using a leaching solution containing amino acid and ammonia, has been tested. Table 8 lists the metals content of the tested nickel concentrate containing the precious and PGM metals.

TABLE 8

| | Au, | Ag, | Pd, | Pt, | Ni, | Fe, | Ca, | Mg, | S, | Mn, | Co, | Zn, | Cu, |
|---|---|---|---|---|---|---|---|---|---|---|---|---|---|
| Sample | ppm | ppm | ppm | ppm | % | % | % | % | % | % | % | % | % |
| Ni | 0.51 | 1.5 | 1.08 | 0.3 | 6.1 | 33.5 | 0.33 | 4.04 | 6.04 | 0.09 | 0.12 | 0.012 | 0.30 |
| conc. | | | | | | | | | | | | | |

Table 9 sets out the leach conditions and metals extracted (%) from the Ni-concentrate containing precious and PGMs (palladium and platinum) metals when leached using a solution containing 0.5 mol/L glycine and 1.1 mol/L ammonia at pH 10.2.

TABLE 9

| Leach conditions and metals extraction | Ni-Conc. |
|---|---|
| Solid, % | 10 |
| Ammonia, mole | 1.1 |
| Glycine, mole | 0.5 |
| Residence time, hours | 72 |
| Ni Extraction, % | 90.9 |
| Co Extraction, % | 85.5 |
| Pd Extraction, % | 44.5 |
| Au Extraction, % | 60.1 |
| Pt Extraction, % | 19.9 |
| Ag Extraction, % | 51.2 |

The results in Tables 8 and 9 indicate that high recoveries of Ni and Co, and reasonable to good recoveries of precious metals comprising Au, Ag, Pd and Pt, can be achieved at alkaline pH by leaching with a glycine and ammonia solution.

### Example 11

The extraction of precious metals, including palladium and platinum, from an oxide sample containing gold and platinum group metals (PGMs) using a leaching solution containing amino acid and ammonia, has been tested. Table 10 lists the metals content of the tested oxide sample.

TABLE 10

| Sample | Au, ppm | Pd, ppm | Pt, ppm |
|---|---|---|---|
| Oxide sample | 0.05 | 2.53 | 0.38 |

In the glycine-ammonia system, it was found that increasing one or more of temperature, pH, glycine concentration and dissolved oxygen increases the quantity of precious metals (including palladium and platinum) extracted. The leaching solution contained 0.5 mol/L glycine and 1.1 mol/L ammonia at pH 10.2. The solids content, leach conditions and % metals extracted are listed in Table 11 below.

TABLE 11

| Leach conditions and metals extraction | Oxide sample |
|---|---|
| Solid, % | 12.5 |
| Ammonia, mole | 1.1 |
| Glycine, mole | 0.5 |
| Residence time, hours | 48 |
| Pd Extraction, % | 44.1 |
| Au Extraction, % | 52.1 |
| Pt Extraction, % | 17.9 |

The results in Tables 10 and 11 indicate that reasonable to good recoveries of precious metals comprising Au, Pd and Pt, can be achieved at alkaline pH by leaching with a glycine and ammonia solution.

Whilst a number of specific process embodiments have been described, it should be appreciated that the process may be embodied in many other forms.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

1. A process for recovery of one or more target metals, selected from precious metals and chalcophile metals as respectively herein defined, from materials containing precious and/or chalcophile metals, the process including:
leaching the material containing metals with an aqueous leaching solution containing:
a metal liberator comprising an amino acid; and
a metal retainer comprising one or more of ammonia, ammonium salts, carboxylic acids, carboxylic acid salts, dicarboxylic acids, dicarboxylic acid salts, hydroxy-carboxylic acids, hydroxy-carboxylic acid salts, ethylene diamine tetra-acetic acid (EDTA) and EDTA salts,
to produce a leachate containing the one or more target metals; and
(ii) extracting the one or more target metals from the leachate, wherein the one or more target metals are selected from gold, silver, palladium, platinum, copper, nickel, cobalt and zinc; and
wherein the metal retainer is present in solution at a concentration of at least 0.001 M.

2. The process of claim 1, wherein the amino acid comprises one or more of Glycine, Histidine, Valine, Alanine, Phenylalanine, Cysteine, Aspartic Acid, Glutamic Acid, Lysine, Methionine, Serine, Threonine, and Tyrosine.

3. The process of claim 2, wherein the amino acid comprises glycine or glutamic acid.

4. The process of claim 1, wherein the amino acid concentration in solution ranges from 0.01 to 250 grams per litre.

5. The process of claim 1, wherein the aqueous leaching solution is substantially free of intentional additions of thiourea and/or transition metal salts.

6. The process of claim 1, wherein the metal retainer comprises ammonia or an ammonium salt.

7. The process of claim 6, wherein the ammonium salt is selected from ammonium sulfate, ammonium halide, ammonium carbonate, ammonium nitrate, ammonium oxalate and ammonium acetate.

8. The process of claim 1, wherein the molar ratio between the one or more target metals in solution and the metal retainer is at least 1:2.

9. The process of claim 1, wherein the leaching is conducted in the presence of an oxidant selected from air (gaseous and dissolved states) and oxygen (gaseous and dissolved states).

10. The process of claim 1, wherein the leaching is conducted in the presence of a small amount of a catalyst.

11. The process of claim 1, wherein the leaching is conducted under alkaline conditions.

12. The process of claim 1, wherein the leaching is conducted under acidic conditions.

13. The process of claim 1, wherein the material containing the precious metal and/or chalcophile metal is selected from an ore, an ore concentrate, a waste material, a mining or metallurgical process intermediate or a metal-contaminated soil.

14. The process of claim 1, wherein the one or more target metals are non-precious metals.

15. The process of claim 14, wherein the one or more target metals are selected from nickel, cobalt and copper.

16. The process of claim 15, wherein the one or more target metals are selected from nickel and cobalt.

17. The process of claim 13, wherein the material containing metals is a nickel and/or cobalt ore.

18. The process of claim 14, wherein the one or more target metals is copper.

19. The process of claim 13, wherein the material containing metals is e-waste.

20. The process of claim 1, wherein the aqueous leaching solution includes a dissolved oxygen concentration of 0.1-100 milligrams per litre.

21. The process of claim 1, wherein the mass ratio of metal liberator: metal retainer is at least 2:1.

22. A target metal recovered from the process of claim 1.
